(19) United States
(12) Patent Application Publication
(10) Pub. No.: US 2017/0233953 A1
(43) Pub. Date: Aug. 17, 2017

(54) COVERING LAYERS FOR ELASTIC LAMINATE THAT COMPRISE A SEPARATE SURFACE COATING

(71) Applicant: Metall-Chemie Technologies GmbH, Hamburg (DE)

(72) Inventors: Helmut KIPPHARDT, Hamburg (DE); Oliver SCHAAL, Erndtebruck (DE)

(21) Appl. No.: 15/325,510

(22) PCT Filed: Jul. 10, 2015
(86) PCT No.: PCT/EP2015/001414

§ 371 Date: Mar. 30, 2017

(30) Foreign Application Priority Data
Jul. 11, 2014 (DE) 10 2014 010 252.1

(51) Int. Cl. D21H 27/24; C09D 133/00; C08J 7/04; B05D 3/02; D21H 19/24; D21H 27/28; B32B 29/00; B05D 1/28; C09D 175/04; D21H 19/26

(52) U.S. Cl. CPC D21H 27/24; C09D 175/04; C09D 133/00; C08J 7/042; D21H 19/26; D21H 19/24; D21H 27/28; B32B 29/002; B05D 1/28; B05D 3/0254; C08J 2375/04; C08J 2333/00; B32B 2260/028; B32B 2260/046; B32B 2264/107; B32B 2307/412; B32B 2307/51

(57) ABSTRACT

The invention relates to a method for producing a covering layer for elastic laminate comprising a) impregnating a carrier fabric, b) applying a surface coating comprising a crosslinker and a prepolymer that can be crosslinked via reactive end groups, c) crosslinking the crosslinkable prepolymer, and d) drying the elastic laminate covering layer. The papers obtainable in this manner are suitable for producing a laminate that, with the elastic outer face thereof, has a pleasant and appealing feel underfoot and good haptics.

The invention pertains to a process for the production of elastic laminate cover layers in the form of treated overlay or decorative papers that can be used as outer layer for a laminate board (like e.g., decorative floor covering, wall or ceiling covering panels (for indoor and outdoor use), furniture components and coverings, building, cover or dry wall panels, facades, panel or floor board elements, screens etc.) having a core panel. The present invention also pertains to the elastic laminate cover layers as such that are obtainable by this process, their use as outer layer in the production of the above-mentioned laminate boards, as well as the laminate boards that are obtainable by using the elastic laminate cover layers according to the invention.

The process for the production of the elastic laminate cover layers according to the invention comprises at least the following steps:
a) impregnating a carrier fabric with a first suitable resin mixture,
b) applying one-sidedly a second resin mixture as surface coating comprising a cross-linker and a prepolymer that is crosslinkable via reactive end groups,
c) crosslinking the prepolymer that is crosslinkable via reactive end groups and
d) drying the elastic laminate cover layer.

With the laminate cover layers that are obtainable by the process according to the invention, a laminate is provided that, with its elastic outer surface, gives the user not only an agreeable and, in comparison to known laminates, pleasing walking sensation, but also a good haptic. In addition, this leads to a significant impact and sound reduction, depending on the choice of the prepolymers used in the process according to the invention, which e.g., allows to dispense with the use of underside impact sound insulation panels that are regularly used in the processing of conventional laminated flooring panels with an outer layer consisting of melamine/formaldehyde-condensation resin (MF). Due to the elasticity of the surface of the cover layer according to the invention, the properties with regard to compressive and impact stress of the products also improve, and the elasticity of the surface and the use of the elastic cover layers according to the invention lead to a pleasing foot warmth that is noticeable for the user. The use of the elastic cover layers according to the invention as surface of e.g., furniture components results in a haptic that is particularly pleasing for the user.

In comparison to conventional laminated floorings—in particular those with a wear layer out of MF—the use of the elastic cover layers according to the invention results in significant advantages. With “hard” laminated floorings, cracks in the surface of the laminate can result from a corresponding strain, so that a possible entry of moisture and/or chipping of the surface restrict the use of the laminate. Due to the elasticity of the cover layers according to the invention, no such problems arise in the present case. Furthermore, with a “soft” or elastic cover layer, a sharp edge cut is possible, so that the stress-whitening observed during the cutting of “hard” laminate panels does not occur. Moreover, spalling at the edges can be largely avoided through the use of the elastic cover layers according to the invention. Thus, the cutting of individual panels does not result in any damages, and a thoroughly satisfying optical-aesthetic impression is created.

Elastic laminate cover layers comprising a functional layer and a separately-applied wear layer that can be used as outer layer for the production of laminate flooring panels, are already known from EP 2 263 867 and DE 10 2013 007 236. However, the elastic cover layers described in EP 2 263 867 and DE 10 2013 007 236 are obtained in a technically relatively demanding way, namely by extruding a film on a paper, which is potentially only partly-impregnated, in a separate step that is carried out in a sequential manner. These cover layers known from the prior art are also subsequently processed into laminates such as flooring panels according to known methods. For this purpose, the complete assembly consisting of the cover layer, optionally a decorative paper, a core panel and a backing is pressed via hot-pressing with a press to form a laminate. When using a separate decorative paper, the cover layer, in this case an overlay paper, must necessarily be transparent, and, when using the overlay papers known from the state of the art in the process known from the state of the art, there is often a problematic formation of bubbles inside and also underneath the overlay paper and corresponding disruptions of the transparency, as well as a sticking of the laminate to the press plate of the press.

The present invention sets itself the task of providing a new form of a laminate cover layer that is completely transparent when using a separate decorative paper (when the laminate cover layer acts as overlay paper), the use of which in all cases (also when the laminate cover layer itself according to the invention comprises a decorative paper) completely prevents the formation of bubbles and does not lead to a sticking of the laminate to the press plates. Furthermore, the present invention allows the provision of laminate cover layers that are bound extremely tightly with the other components of the laminate and that are also resistant to chemicals, abrasion, scratching, and light. The process according to the invention allows to avoid ecologically problematic compounds and additives such as PVC, plasticizers, anti-oxidants and UV-stabilizers, whereby e.g., by avoiding plasticizers, the overlay papers according to the invention are non-fogging; i.e., there is no leakage of volatile components (e.g., plasticizers based on phthalates), which, when using conventional laminate cover layers, regularly condensate on window panes, walls and carpets. Finally, the laminate cover layers according to the invention can be produced via technically simple, affordable and, with the preferential use of purely aqueous systems, ecologically unproblematic methods, and processed into laminates.

One aspect of the present invention consists therefore in providing a haptically-demanding, “soft” surface, which, on the one hand, by avoiding PVC, is free of chlorine and, on the other hand, is free of plasticizers. By providing a chlorine-free product, on the one hand (e.g., in combination with the waste disposal) an environmentally-friendly material is provided, which completely avoids the problems associated with the use of PVC that were known from the state of the art. In addition, the known problems associated with surfaces containing plasticizers that result from the evaporation of the plasticizer from conventional “soft” materials, such as the films known from the state of the art, are avoided; in particular, the cover layers provided by the present invention that are to be used as outer layers of laminates are non-fogging. By using corresponding prepolymers, the used resin mixtures can be formulated so that they are free of antioxidants, plasticizers and UV-stabilizers, and the laminate cover layers obtainable in this way are nonetheless completely transparent, resistant to oxidation and lightfast; the UV-stability (i.e. lightfastness) of the cover layers according to the invention is achieved, in particular, due to the fact that at least the second resin mixture used for the surface coating is free of prepolymers that have a tendency towards yellowing with UV radiation; purely aliphatic polyurethane prepolymers and polyurethane prepolymers that are based on tetramethylxylylendiisocyanate (TMXDI) are particularly suited for this purpose. It is particularly preferred when both the first resin mixture used for the impregnation and the second resin mixture used for the surface coating are free of prepolymers that have a tendency towards yellowing with UV radiation.

A further aspect of the present invention is to provide elastic laminate cover layers that can be manufactured via a technically simple, affordable and environmentally-friendly process. For this purpose, the complete set-up of the laminate cover layers according to the invention enables the manufacture in applicable units known from the state of the art, in which, in a first step, a dip impregnation, i.e., a complete soaking of the carrier fabric in a suitable resin system, takes place. Possible carrier fabrics are, on the one hand, pulp sheets with basis weights of about 20 to 150 g/m² that e.g., consist of pulp or alpha-cellulose, and can also have incorporated corundum. By applying the process according to the invention, such carrier fabrics yield a fully transparent overlay paper. On the other hand, the carrier fabric used in the process according to the invention can also be a non-printed, colour-printed (e.g., via digital printing) or through-coloured decorative paper.

The suitable resin system used for the dip impregnation is present in the form of a solution, emulsion or dispersion of a suitable resin system in water or in an organic solvent; preferably, the suitable resin system used for the dip impregnation is an aqueous dispersion. The suitable resin system can contain, next to suitable resins and prepolymers, hard particles, crosslinkers as well as excipients such as a wetting or separating agent, or a defoamer; it is preferably free of plasticizers, antioxidants and UV-stabilizers.

Excess resin after the dip impregnation is removed via well-known methods such as by using metal blades or metering rollers and the impregnated fabric is optionally subjected to an intermediate drying. The optional intermediate drying takes place preferentially up to a residual moisture of 5 to 25%.

A second resin system is applied one-sided (e.g. by using a grid work) as a surface coating on the pre-impregnate obtained in this way. The resin system used as surface coating is present in form of a solution, emulsion or dispersion in water or in an organic solvent; preferably the resin system used for the surface coating is an aqueous dispersion. The resin system used for the surface coating contains prepolymers that are crosslinkable via reactive end groups, as well as at least one crosslinker, and it can also contain hard particles and excipients such as a wetting or separating agent, or a deformer; preferably, the resin system used for the surface coating is free of plasticizers, antioxidants and UV-stabilizers. The dosing of the surface coating is carried out e.g., using anilox rollers. Through the reaction of the reactive end groups with the crosslinker contained in the second resin mixture, a crosslinkage of the prepolymer that is crosslinkable via reactive end groups takes place, in particularly during the subsequent drying of the impregnated fabric that is provided with a surface coating.

The second resin mixture used for the surface coating comprises a prepolymer that is crosslinkable via reactive end groups and a crosslinker, as well as—optionally—further excipients (such as a wetting/separating agent or a defoamer) and hard particles. The second resin mixture can also contain a system forming a separate network (e.g., a combination of diketoacrylamide and adipic acid dihydrazide). The prepolymers contained in the resin mixtures in the form of corresponding dispersions are polymeric compounds that reach a higher polymerization grade via further reactions after application of the resin mixtures. The prepolymers that are crosslinkable via reactive end groups can be e.g., polyurethane (PUR), polyacrylate, polyurea, as well as corresponding copolymers or hybrids of polyurethane or polyurethane-copolymers with polyacrylates. The prepolymers that are crosslinkable via reactive end groups are preferably polyurethane-polyacrylate-hybrid polymers, polyurethane-polyurea-copolymers or combinations thereof. In the case of polyurethane-polyacrylate-hybrid polymers, the polyurethane/polyacrylate ratio (weight %/weight %, based on the solid resin content of the dispersion used) can lie between 95:5 and 5:95; preferably, the ratio lies between 50:50 and 30:70, more preferably, the ratio lies between 20:80 and 10:90.

The reactive end groups of the crosslinkable prepolymers are in particular amino-(—NH₂ and —NHR), hydroxy-(—OH), carboxy/carboxylate-(—COOH/—COO⁻), as well as mercapto groups (—SH). Preferably, the reactive end groups of the crosslinkable prepolymers are primary amino groups (—NH₂), hydroxy groups (—OH) and carboxy/carboxylate groups (—COOH and —COO⁻). In contrast to such suitable reactive end groups, the resins and prepolymers that are to be used according to the invention do not contain any end groups that react with the concomitant release of gases; in particular, with regards to the use of polyurethane-prepolymers, isocyanate end groups do not represent suitable reactive end groups. The prepolymers that are crosslinkable via reactive end groups are in particular polymers, copolymers and hybrids of polyurethanes that are crosslinkable via primary amino groups (—NH₂) and/or polyacrylates that are cross-linkable via OH-groups. The prepolymers that are crosslinkable via reactive end groups are most preferably polyurethanes that are crosslinkable via NH₂-groups, polyacrylates that are crosslinkable via OH-groups or polyurethane-polyacrylate-hybrid polymers whose polyurethanes are crosslinkable via NH₂-groups and/or whose polyacrylates are crosslinkable via OH-groups. Ready-to-use polyurethane/polyacrylate-hybrid-prepolymers, which contain a polyurethane that is crosslinkable via NH₂-groups are marketed under the label Ecronova ET 2012 and Ecronova ET 4075. A polyacrylate-prepolymer that is crosslinkable via OH-groups is obtainable as Ecronova Ecrylic RA646A.

Suitable resins and prepolymers for the dip impregnation are basically all products that can bind physically and/or chemically to the surface coating. This includes, amongst other, polyurethane (PUR), including polyurethane-copolymers, polyurethane-polyacrylate-hybrids and mixtures thereof, polyacrylates, including polyacrylate-copolymers, polyacrylate/polyurethane-hybrids and mixtures thereof, modified melamine resins, polyureas, including copolymers and mixtures thereof, polyacrylamides, including polyacrylate-copolymers and mixtures thereof, polyethylene vinyl alcohol, polyethylene vinyl acetate, epoxy resins and silicones. Ready-to-use dispersions of polyurethane and polyacrylate polymer dispersions that are not further crosslinkable via functional groups and that, through the use of a crosslinker, e.g. an isocyanate, result in a polyurethane/polyacrylate/polyurea-interpenetrating network-polymer are commercially available under the labels Bayer Impranil DLC-F (polyurethane-polymer) or Helios Domemul 7960 (Polyacrylat-Polymer).

Through the penetration of prepolymers and the crosslinker out of the surface coating into the surface of the pre-impregnate and the subsequent crosslinking of the reactive end groups, a tight physical bond is formed between the functional layer introduced as pre-impregnate and the wear layer applied as surface coating via the formation of a hybrid-polymer. Suitable resins and pre-polymers for the dip impregnation are preferably those that, via their own reactive groups (e.g., NH₂—, OH—, COOH or SH-groups), can form a chemical bond mediated by the crosslinker with the prepolymers of the resin system used in the surface coating that are crosslinkable via reactive end groups; particularly preferred suitable resins and pre-polymers for the dip impregnation are MF-polymers, polyacrylates and polyurethanes, whereby the polyurethanes and polyacrylates that are crosslinkable via reactive end groups are particularly preferred. According to the invention, for the impregnation, resin mixtures that contain polyurethanes which are crosslinkable via NH₂-groups or polyacrylates which are crosslinkable via OH-groups (optionally in the form of mixtures, co-polymers or polyurethane/polyacrylate-hybrids) should most preferably be used. According to the invention, polyurethane/polyacrylate-hybrids whose polyurethane portion is crosslinkable via NH₂-groups and/or whose polyacrylate portion is crosslinkable via OH-groups are preferably used.

According to the invention, isocyanates, epoxides and aziridines are suitable as crosslinkers; water-dispersible di-bis polyisocyanates, water-dispersible di-bis polyepoxides as well as water-dispersible di-bis polyaziridines are preferred. According to the invention, blocked isocyanates that unblock during the drying and can bring about a crosslinking can also be used as crosslinkers. According to the invention, water-dispersible di-bis polyisocyanates are particularly preferred. Possible crosslinkers are marketed commercially e.g., under the labels Dancure 101 (aliphatic polyisocyanate), Bayhydur XP 2655 (aliphatic polyisocyanate based on hexamethylene diisocyanate) and Desmodur DN (hydrophilic, aliphatic polyisocyanate based on hexamethylene diisocyanate). The proportion of the crosslinker in the first and the second resin mixture can be 0.5-50 weight % (wet-wet), preferably 5-25 weight % (wet-wet) and most preferably 0.5-10 weight % (wet-wet).

Both the functional layer and the wear layer of the laminate cover layers according to the invention can contain particles of corundum, silicon carbide or titanium nitride; the hard particles are preferably silanized. The hard particles can already be contained in the resin mixtures used for the application of the dip impregnation and/or for the application of the surface coating, or they can be sprinkled after their application. Fine particles with an average particle size of 0.5 to 30 μm for improving the scratch resistance and coarse particles with an average particle size of 30 to 150 μm for improving the abrasion resistance are suitable for this purpose, as known from the state of the art. The resin mixture used for the dip impregnation preferably contains coarse particles and the resin mixture used for the surface coating preferably contains fine particles. Alternatively, coarse particles can be sprinkled after the application of the first resin mixture and/or fine particles can be sprinkled after the application of the second resin mixture and before the respective (intermediate) drying.

The process can be carried out on a technically very simple set-up and provides elastic laminate cover layers, whereby the surface (the wear layer), which is optionally resistant to chemicals, abrasion and scratches, must not be applied sequentially as a separate film, and whereby the wear layer, whilst avoiding adhesive and coupling agents, binds extremely tightly to the impregnated core (the functional layer) of the cover layer. This is achieved by the fact that the polymers used in the surface coating are crosslinkable via reactive end groups and bind physically and/or chemically via a crosslinker contained in the surface coating to the polymer used for the impregnation; preferably, a chemical binding mediated by the cross-linker also takes place between the polymers from the second resin mixture used for the surface coating and the material in the first resin mixture used for the impregnation.

The elastic laminate cover layers obtainable by the process according to the invention are used as decorative and/or protective layers for surfaces, in particular as outer layer for the manufacture of novel laminated panels. For this purpose, the cover layers obtainable via the process according to the invention are applied according to standard procedures on suitable carrier systems (e.g., HDF-, MDF-, chipboards, plywood and OSB-panels, veneers, mineral panels, synthetic materials, metals, plaster or the like such as composite materials etc.). Preferably, the core panel has so-called click-connections on opposite sides that function in the manner of a tongue and groove system. Due to the specific configuration of the cover layers according to the invention, such panels have significant advantages over classical laminated panels.

The laminate cover layers according to the invention are processed into layered structures (laminates) such as flooring panels according to known methods. In so doing, the complete assembly of the cover layer, optionally a decorative paper, a core panel and a backing is pressed together into a laminate via hot-pressing with a press. Through the use of a separate decorative paper, the laminate cover layer according to the invention, which in this case is acting as overlay paper, is completely transparent and lightfast; alternatively, a preferably digitally printed or a coloured or through-coloured (decorative) paper can be used as carrier fabric for the laminate cover layer according to the invention. Of course, the pressing is always carried out in such a way that the side of the laminate cover layer onto which the surface coating is applied faces the outside of the laminate. Directly after the drying of the cover layers according to the invention or directly after the pressing of the laminate according to the invention, a three-dimensional surface structure can be produced on these, optionally via embossing, whereby fine structures, which are typical for e.g., veneers, are permanently incorporated into the wear layer of the cover layer.

The layered structures obtainable by the process according to the invention exhibit good acoustic properties, in particular an effective body, impact and footfall sound insulation. Furthermore, these cover layers exhibit improved surface properties, whereby above all, compared to conventional elastic flooring panels of the state of the art (e.g., PVC floors), the abrasion resistance is significantly increased and can be even further improved by the addition of hard particles in the surface coating. Finally, the cover layers obtainable by the process according to the invention exhibit improved properties with regards to peeling strength, cleavage strength and abrasion resistance, which is achieved via the physical and, preferably, chemical bonding adhesion of the entire structure.

The outer layer (wear layer) resulting from the surface coating consists, after the crosslinking of the used polymer, copolymer or hybrid polymer via reaction with the crosslinker, of the used polymers, which, depending on the crosslinker used, are bound to each other via different bridges. The physically and chemically crosslinked polymers resulting from the crosslinking and the use of hybrid polymers are also bound to suitable polymers of the resin mixture used for the impregnation via the penetration of the surface coating in the pre-impregnate and the resulting formation of hybrid polymers and/or further reactions via the crosslinker contained in the surface coating. This insures a strong bond between the wear layer obtained via the surface coating and the core (functional layer) obtained from the impregnation. The core impregnation acting as a functional layer absorbs mechanical impacts within the assembly and has an effective footfall sound-insulating effect. The outward-facing layer resulting from the surface coating confers to the surface resistance to chemicals, a high scratch resistance, a high abrasion resistance as well as an extremely agreeable haptic.

Without being limited to the following examples, the invention will be further characterized by them.

### COMPARATIVE EXAMPLE 1

Impregnation with an aqueous dispersion comprising a non-functional polyurethane (without reactive end groups) and a non-functional polyacrylate (also without reactive end groups) with the addition of a crosslinker in order to form a separate polyurea network and to bring about a polyurethane-polyacrylate-polyurea “interpenetrating network”.

### Resin Mixture for the Core Impregnation:

| | |
|---|---|
| PUD: Bayer Impranil DLC-F | 750 g |
| Polyacrylate: Helios Domemul 7960 | 250 g |
| Water | 100 g |
| Crosslinker polyisocyanate Dancure 101 | 100 g |
| Wetting/separating agent Deurowood MA7 | 10 g |

### Dip Impregnation

Wet impregnation 1: smooth up/smooth down, 20 seconds pre-drying
Wet impregnation 2: 600 μm/700 μm (distance between the grooves of the squeegee), 90 seconds drying

### Result:

| | |
|---|---|
| Final weight: | 128 g/m² |
| Residual moisture: | 6.5% |
| Resin applied: | 97.7 g/m² |

Strong sticking to the press plate, visible and flat transparency disruptions

### COMPARATIVE EXAMPLE 2

Impregnation with an aqueous dispersion comprising a polyurethane/polyacrylate-hybrid-polymer, whereby the polyurethane in the polyurethane/polyacrylate-hybrid-polymer is crosslinkable via NH₂-groups; use of a corundum-filled overlay with a basis weight of 25 g/m² and with 3 g/m² of corundum

### Resin Mixture Core Impregnation

| | |
|---|---|
| PUR/polyacrylate-hybrid: Ecronova ET 2012 | 1000 g |
| Water | 200 g |
| Wetting/separating agent Deurowood MA7 | 10 g |

### Pre-Impregnation

Wet impregnation 1: 800 μm/800 μm, 20 seconds pre-drying
Wet impregnation 2: 800 μm/800 μm, 145 seconds drying

### Result:

| | |
|---|---|
| Final weight: | 125 g/m² |
| Residual moisture: | 4.3% |
| Resin applied: | 95.5 g/m², |

Complete sticking to the press plate, mechanically not separable anymore from the press plate, press plate destroyed and an absolutely unusable product

### EXAMPLE 1

Impregnation with an aqueous dispersion comprising a polyurethane prepolymer that is crosslinkable via NH₂-groups; surface coating with an aqueous dispersion comprising a polyacrylate that is linkable via OH-groups and additionally self-linkable

### Resin Mixture for the Core Impregnation:

| | |
|---|---|
| PUD Ecronova ET 4075 | 1000 g |
| Water | 150 g |
| Crosslinker Bayhydur XP 2655 | 20 g |
| Wetting/separating agent Deurowood MA7 | 10 g |

### Dip Impregnation

Wet impregnation 1: 500 μm/500 μm, 20 seconds pre-drying
Wet impregnation 2: 500 μm/500 μm, 90 seconds drying

### Resin Mixture for the Surface Coating

| | |
|---|---|
| Polyacrylate Ecronova Ecrylic RA646H | 1000 g |
| Water | 200 g |
| Crosslinker Bayhydur XP 2655 | 100 g |
| Wetting/separating agent Deurowood MA7 | 10 g |

### Surface Coating

400 μm, 110 seconds drying

### Result:

Final weight: 115 g/m²
Residual moisture: 2.6%
Resin applied: 90 g/m², core 58 g/m², surface 32 g/m²
No sticking to the plate, transparent

### EXAMPLE 2

Impregnation with an aqueous dispersion comprising a polyurethane pre-polymer that is crosslinkable via NH₂-groups; surface coating with an aqueous dispersion comprising a polyacrylate that is linkable via OH-groups and additionally self-linkable; use of a corundum-filled overlay with a basis weight of 25 g/m² and with 3 g/m² of corundum

### Resin Mixture Core Impregnation

| | |
|---|---|
| PUD: Ecronova ET 4075 | 1000 g |
| Water | 150 g |
| Crosslinker Bayhydur XP 2655 | 20 g |
| Wetting/separating agent Deurowood MA7 | 10 g |

### Dip Impregnation

Wet impregnation 1: 800 μm/800 μm, 20 seconds pre-drying
Wet impregnation 2: 800 μm/800 μm, 110 seconds drying

### Resin Mixture Surface Coating

| | |
|---|---|
| Polyacrylate Ecronova Ecrylic RA646H | 1000 g |
| Water | 200 g |
| Crosslinker Bayhydur XP 2655 | 100 g |
| Microcorundum WCA5 | 100 g |
| Wetting/separating agent Deurowood MA7 | 10 g |

### Surface Coating

600 μm, 90 seconds drying

### Result:

Final weight: 123.4 g/m²
Residual moisture: 2.3%
Resin applied: 96 g/m², core 56 g/m², surface 40 g/m²
No sticking to the plate, transparent
Abrasion resistance 1700 revolutions according to DIN 13329
Resistance to micro-scratches MSR-A2 (reduction in the degree of gloss)
MSR-B3 (micro-scratching)

### EXAMPLE 3

Impregnation with an aqueous dispersion comprising a polyurethane/polyacrylate-hybrid-polymer, whereby the polyurethane in the polyurethane/polyacrylate-hybrid-polymer is crosslinkable by NH₂-groups; surface coating with an aqueous dispersion comprising a polyacrylate and a polyurethane/polyacrylate-hybrid-polymer, whereby the polyacrylate is cross-linkable via OH-groups and self-linkable, and the polyurethane in the polyurethane/polyacrylate-hybrid-polymer is crosslinkable via NH₂-groups; use of a corundum-filled overlay with a basis weight of 25 g/m² and with 3 g/m² of corundum

### Resin Mixture Core Impregnation

| | |
|---|---|
| PUR/polyacrylate-hybrid: Ecronova ET 2012 | 1000 g |
| Water | 200 g |
| Wetting/separating agent Deurowood MA7 | 10 g |

### Dip Impregnation

Wet impregnation 1: 800 μm/800 μm, 20 seconds pre-drying
Wet impregnation 2: 800 μm/800 μm, 145 seconds drying

### Resin Mixture Surface Coating

| | |
|---|---|
| Polyacrylate Ecronova Ecrylic RA646H | 900 g |
| PUR-polyacrylate-hybrid; Ecronova ET 2012 | 100 g |
| Crosslinker Bayhydur XP 2655 | 100 g |
| Microcorundum WCA5 | 100 g |
| Wetting/separating agent Deurowood MA7 | 10 g |

### Surface Coating

400 μm, 100 seconds drying

### Result:

Final weight: 155 g/m²
Residual moisture: 3.3%
Resin applied: 125 g/m², core 95 g/m², surface 30 g/m²
No sticking to the plate, transparent
Abrasion resistance 1350 revolutions according to DIN 13329
Resistance to micro-scratches MSR-A3 (reduction in the degree of gloss)
MSR-B3 (micro-scratching)

### EXAMPLE 4

Impregnation with an aqueous dispersion comprising a polyurethane/polyacrylate-hybrid-polymer, whereby the polyurethane in the polyurethane/polyacrylate-hybrid-polymer is crosslinkable via NH₂-groups; surface coating with an aqueous dispersion comprising a polyacrylate and a polyurethane/polyacrylate-hybrid-polymer, whereby the polyacrylate is crosslinkable via OH-groups and self-linkable, and the polyurethane in the polyurethane/polyacrylate-hybrid-polymer is cross-linkable via NH₂-groups; use of a corundum-filled overlay with a basis weight of 25 g/m² and with 3 g/m² of corundum

### Resin Mixture Core Impregnation

| | |
|---|---|
| PUR/acrylate-hybrid: Ecronova ET 2012 | 1000 g |
| Water | 200 g |
| Wetting/separating agent Deurowood MA7 | 10 g |

Wet impregnation 1: 800 μm/800 μm, 20 seconds pre-drying
Wet impregnation 2: 800 μm/800 μm, 60 seconds intermediate drying
Wet impregnation 3: 800 μm/800 μm, 150 seconds intermediate drying

### Resin Mixture Surface Coating

| | |
|---|---|
| Polyacrylate Ecronova Ecrylic RA646H | 800 g |
| PUD: Ecronova ET 2012-1036-2 | 200 g |
| Crosslinker Bayhydur XP 2655 | 100 g |
| Microcorundum WCA5 | 100 g |
| Wetting/separating agent Deurowood MA7 | 10 g |

### Surface Coating

one-sided 500 μm, 130 seconds drying

### Result:

Final weight: 142 g/m²
Residual moisture: 2.5%
Resin applied: 123 g/m², core 92 g/m², surface 31 g/m²
No sticking to the plate, transparent
Abrasion resistance 1400 revolutions according to DIN 13329
Resistance to micro-scratching MSR-A2 (reduction of the degree of gloss)
MSR-B3 (micro-scratching)

### EXAMPLE 5

Impregnation with an aqueous dispersion comprising a non-functional polyurethane (without reactive end groups); surface coating with an aqueous dispersion comprising a polyacrylate that is linkable over OH-groups and additionally self-linkable; use of a corundum-filled overlay with a basis weight of 25 g/m² and with 3 g/m² of corundum

### Resin Mixture for the Core Impregnation:

| | |
|---|---|
| PUD: Imperial DLC-F | 1000 g |
| Water | 100 g |
| Wetting/separating agent Deurowood MA7 | 10 g |

### Dip Impregnation

Wet impregnation 1: 500 μm/500 μm, 20 seconds pre-drying
Wet impregnation 2: 500 μm/500 μm, 110 seconds drying

### Resin Mixture for the Surface Coating

| | |
|---|---|
| Polyacrylate Ecronova Ecrylic RA646H | 1000 g |
| Water | 50 g |
| Crosslinker Bayhydur XP 2655 | 100 g |
| Wetting/separating agent Deurowood MA7 | 10 g |
| Microcorundum WCA5 | 100 g |

### Surface Coating

600 μm, 110 seconds drying

### Result:

Final weight: 134 g/m²
Residual moisture: 2.8%
Resin applied: 130 g/m², core 79 g/m², surface 26 g/m²
No sticking to the plate, transparent
Abrasion resistance 750 revolutions according to DIN 13329
Resistance to micro-scratches MSR-A3 (decrease in the degree of gloss)
MSR-B3 (micro-scratching)

### EXAMPLE 6

Impregnation with an aqueous dispersion comprising a non-functional polyurethane (without reactive end groups); surface coating with an aqueous dispersion comprising a polyacrylate that is linkable via OH-groups and additionally self-linkable and a non-functional polyurethane (without reactive end groups); use of a corundum-filled overlay with a basis weight of 25 g/m² and with 3 g/m² of corundum

### Resin Mixture for the Core Impregnation:

| | |
|---|---|
| PUD: Impranil DLC-F | 1000 g |
| Water | 150 g |
| Wetting/separating agent Deurowood MA7 | 10 g |

### Dip Impregnation

Wet impregnation 1: 800 μm/800 μm, 20 seconds pre-drying
Wet impregnation 2: 800 μm/800 μm, 110 seconds drying

### Resin Mixture for the Surface Coating

| | |
|---|---|
| Polyacrylate: Ecronova Ecrylic RA646H | 900 g |
| PUD: Impranil DLC-F | 100 g |
| Water | 50 g |
| Crosslinker Bayhydur XP 2655 | 100 g |
| Wetting/separating agent Deurowood MA 7 | 10 g |
| Microcorundum WCA5 | 100 g |

### Surface Coating

400 μm, 90 seconds drying

### Result:

Final weight: 134 g/m²
Residual moisture: 2.0%
Resin applied: 131 g/m², core 80 g/m², surface 26 g/m²
No sticking to the plate, transparent
Abrasion test 780 revolutions according to DIN EN 13329
Micro-scratching MSR-A2 (decrease in the degree of gloss)
MSR-B3 (micro-scratching)

1. A process for the production of an elastic laminate cover layer comprising the steps of:
a. impregnating a carrier fabric with a first resin mixture,
b. applying one-sidedly a second resin mixture as a surface coating comprising a crosslinker and a prepolymer that is crosslinkable via reactive end groups,
c. crosslinking of the prepolymer, and
d. drying the resulting elastic laminate cover layer.

2. The process according to claim 1, whereby the reactive end groups are selected from the group consisting of amino, hydroxy, carboxy/carboxylate and mercapto functions.

3. The process according to claim 1 further comprising an intermediate drying of the impregnated carrier fabric before the application of the second resin mixture.

4. The process according to claim 1 wherein the carrier fabric is an overlay paper of alpha-cellulose.

5. The process according to claim 1 wherein the carrier fabric is a printed, coloured or through-coloured decorative paper.

6. The process according to claim 1 wherein the first and the second resin mixtures are aqueous or organic dispersions and optionally comprise at least one further excipient.

7. The process according to claim 1 wherein at least one of the first and the second resin mixtures contains hard particles of corundum, silicon carbide or titanium nitride with an average particle size of 0.5 to 150 μm.

8. The process according to claim 3 wherein, after the application of at least one of the first and the second resin mixture and before the respective drying, hard particles of corundum, silicon carbide or titanium nitride with an average particle size of 0.5 to 150 μm are scattered on the respective resin mixture.

9. The process according to claim 1 wherein the first resin mixture comprises at least one of a melamine resin, a polyurethane, a polyacrylate and a polyurethane/polyacrylate-hybrid-polymer, and, optionally, a crosslinker.

10. The process according to claim 9, whereby the polyurethane and the polyacrylate are crosslinkable via reactive end groups.

11. The process according to claim 1 wherein the prepolymer is a polyurethane, a polyacrylate or a polyurethane/polyacrylate-hybrid-polymer.

12. The process according to claim 10 wherein the polyurethane is crosslinkable via NH2-groups and the polyacrylate is crosslinkable via OH-groups.

13. The process according to claim 1 wherein whereby the second resin mixture is free of prepolymers that have a tendency towards yellowing with UV radiation.

14. The process according to claim 1 wherein the first and the second resin mixtures are free of antioxidants, plasticizers and UV-stabilizers.

15. The process according to claim 1 wherein the crosslinker is an isocyanate, an epoxide or an aziridine.

16. An elastic laminate cover layer made by the process of claim 1.

17. The process of claim 1 for the production of a layered structure, whereby the side of the laminate cover layer on which the surface coating is applied faces an outside of the layered structure.

18. (canceled)

19. The process according to claim 11 wherein the polyurethane is crosslinkable via NH2-groups and the polyacrylate is crosslinkable via OH-groups.
